(19) United States
(12) Patent Application Publication
(10) Pub. No.: US 2006/0198990 A1
(43) Pub. Date: Sep. 7, 2006

(54) Memory foam padding adapted to sewing patterns of a sewing machine

(76) Inventor: Tun-Jen Ku, Da-Li City (TW)

Correspondence Address: PRO-TECTOR INTERNATIONAL SERVICES, 20775 NORADA CT., SARATOGA, CA, 95070, US

(21) Appl. No.: 11/363,690

(22) Filed: Feb. 27, 2006

(30) Foreign Application Priority Data
Mar. 2, 2005 (CN) 20052005095.2

(51) Int. Cl. B32B 3/26

(52) U.S. Cl. 428/158; 428/304.4

(57) ABSTRACT

The present invention relates to a memory foam padding adapted to sewing patterns of a sewing machine, which comprises a high-density memory foam layer, a cloth layer, a low-density foam layer, wherein the cloth layer is stuck at the bottom of high-density memory foam layer, and the low-density foam layer is stuck at the bottom of said cloth layer in such a manner that said high-density memory foam layer, cloth layer and low-density foam layer can be a unitary padding, thereafter, a decoration fabric casing will be coated around the padding, thus enabling said padding to be easily advanced to cause a smooth sewing process and three-dimensional patterns thereof while sewing the patterns, by means of the molding of cloth and foam layers.

### BACKGROUND OF THE INVENTION

1. Field of the Invention

The present invention relates to a memory foam padding adapted to sewing patterns of a sewing machine that can be easily advanced to cause a smooth sewing process and three-dimensional patterns while sewing the patterns thereof.

2. Description of the Prior Arts

The conventional paddings such as mattresses, cushions or spring beds are provided in the casing thereof with a foam layer for the comfortness and softness; however, to enhance the comfortness and the aesthetic appearance of paddings, the manufacturers could use the sewing machine to sew the patterns on the surface of paddings. As shown in FIGS. 1 and 2, a casing 11 is covered around a padding 10 and is interiorly provided with a foam layer 12. After sewing, the sewing lines 13 of casing 10 will become arcuate concaves, so as to the appearance of the surface of paddings form three-dimensional patterns. Moreover, after the stretching of said arcuate concaves of sewing lines 13, the convex portions without sewing lines 13 will be strained to enhance the elastic recovery of foam layer 12 such that the comfortness of padding 10 will accordingly be improved.

To improve the properties of low density and poor elasticity of conventional foam materials, the memory foam materials having the properties of high density and good extension have been developed by some manufacturers. Such improved memory foam materials can be used to form the user's lie-down shape on the surface thereof, and the forming portion can attain sufficient supporting force as well. Unfortunately, such memory foam materials can not appear the patterns of sewing thereon; consequently, the purpose of aesthetic appearance still can not be achieved at present.

In addition, it is pretty difficult to straightly sew the patterns on the memory foam layer of padding due to the properties of high density, heavy weight and good extension. Hence, its sewn portions are not easy to be advanced forward while in the pattern sewing process, in such a situation that the sewing machine will always operate at the fixed sewing position, then the memory foam layer will be sewn to become a mass or a breaking.

The present invention has arisen to mitigate and/or obviate the afore-described disadvantages.

### SUMMARY OF THE INVENTION

The primary objective of the present invention is to provide a memory foam padding adapted to sewing patterns of a sewing machine, which comprises a high-density memory foam layer and a molding member, wherein said molding member such as a nonwoven cloth layer is stuck at the bottom of memory foam layer, so as to the memory foam layer and said cloth layer can be a unitary padding, thereafter, a decoration fabric casing will be covered around the padding, thereby enabling said padding to be easily advanced to cause a smooth sewing process and three-dimensional patterns while sewing the patterns thereof, by using the molding of cloth layer.

The secondary objective of the present invention is to provide a memory foam padding adapted to sewing patterns of a sewing machine, which comprises a high-density memory foam layer, a cloth layer, a low-density foam layer, wherein the cloth layer is stuck at the bottom of high-density memory foam layer, and the low-density foam layer is stuck at the bottom of said cloth layer in such a manner that said memory foam layer, cloth layer and foam layer can be a unitary padding, thereafter, a decoration fabric casing will be covered around the padding, thus enabling said padding to be easily advanced to cause a smooth sewing process and three-dimensional patterns while sewing the patterns thereof, by means of the molding of cloth and foam layers.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 shows the sewing patterns of a conventional foam padding;

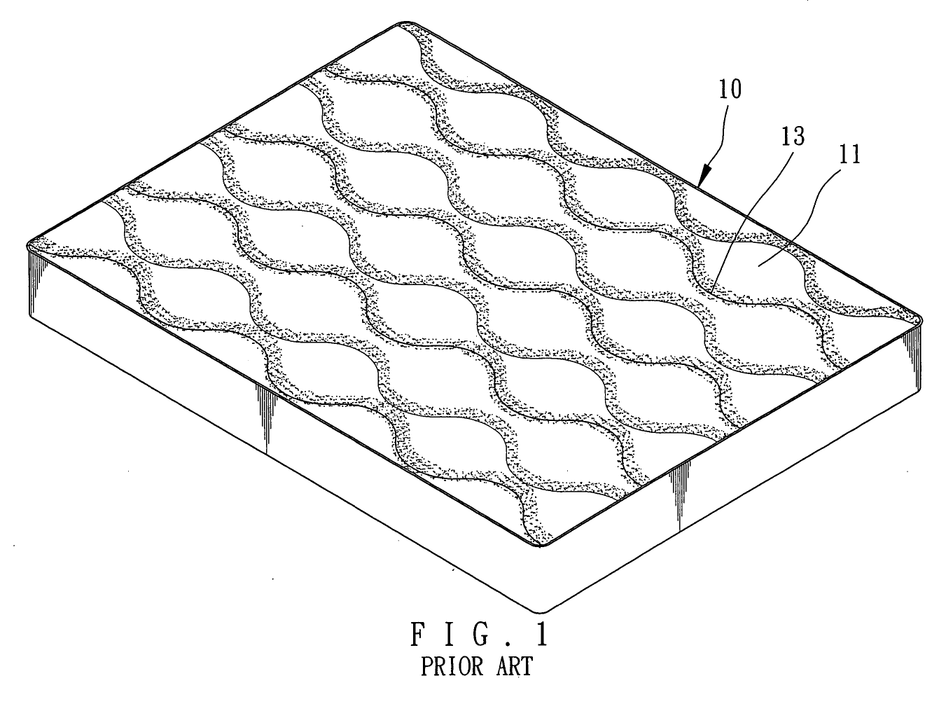

FIG. 2 is a cross-sectional view of sewing patterns of the conventional foam padding;

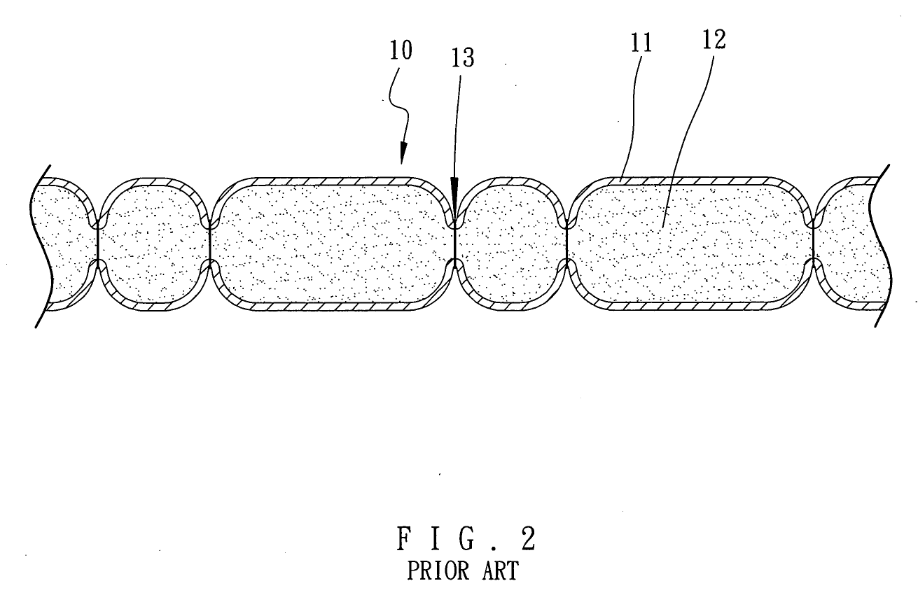

FIG. 3 is an exploded view of a memory foam padding adapted to sewing patterns of a sewing machine in accordance with the present invention;

FIG. 4 is a cross-sectional view of the memory foam padding adapted to sewing patterns of a sewing machine before the sewing process in accordance with the present invention;

FIG. 5 is a perspective view of the memory foam padding adapted to sewing patterns of a sewing machine while in the sewing process in accordance with the present invention;

FIG. 6 shows the memory foam padding adapted to sewing patterns of a sewing machine after the sewing process in accordance with the present invention

FIG. 7 is a cross-sectional view of the memory foam padding adapted to sewing patterns of a sewing machine after the sewing process in accordance with the present invention.

### DETAILED DESCRIPTION OF THE PREFERRED EMBODIMENT

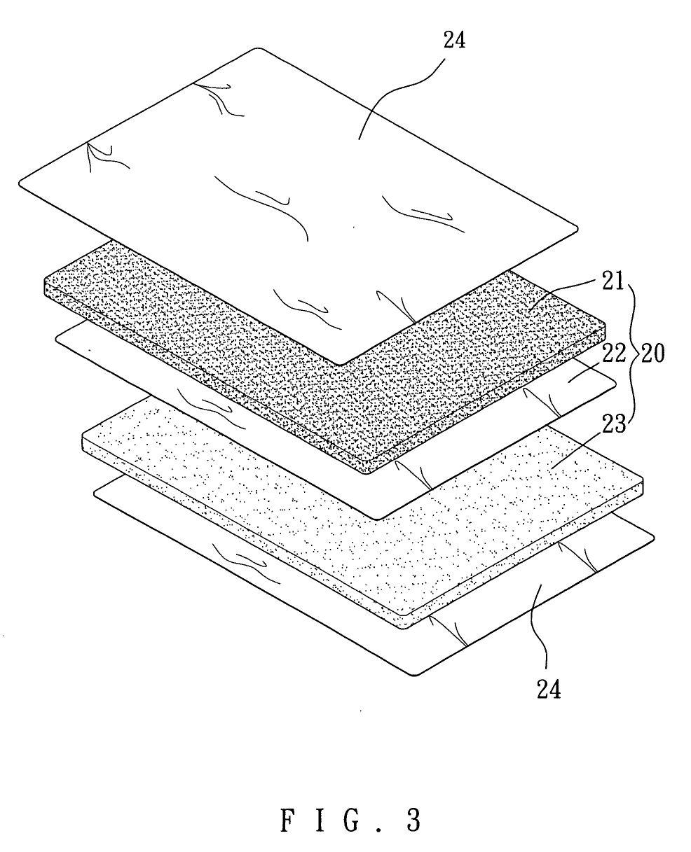

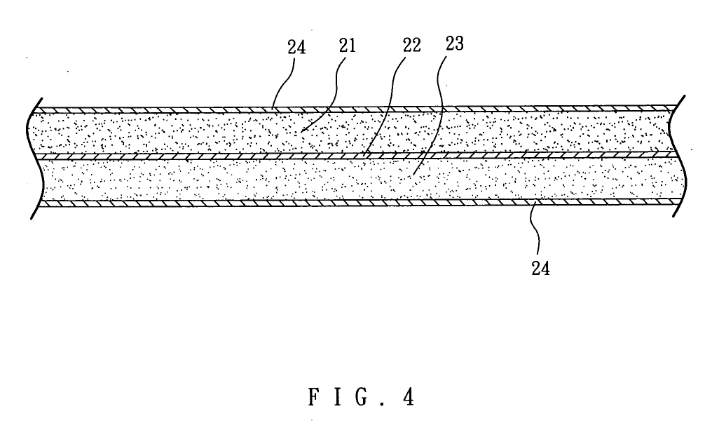

Referring to FIGS. 3-4, a memory foam padding adapted to sewing patterns of a sewing machine in accordance with the present invention is shown and comprises a padding 20, a memory foam layer 21 having the properties of high density and extension, a molding member such as a nonwoven cloth layer 22, a foam layer 23 and a decoration fabric casing 24.

By means of the memory foam layer 21, the lie-down shape of user can be formed on the surface of padding 20, and the user can also feel the comfortness of padding 20. The nonwoven cloth layer 22 is stuck at the bottom of memory foam layer 21. By using the low extension of nonwoven cloth layer 22, the memory foam layer 21 can be formed without randomly exchanging its shape. Thereafter, the foam layer 23 is stuck at the bottom of cloth layer 22, so as to the memory foam layer 21, cloth layer 22 and foam layer 23 can be a unitary padding 20. Further, the decoration fabric casing 24 will be covered around the padding 20 for a smooth sewing process and the aesthetic appearance of padding 20.

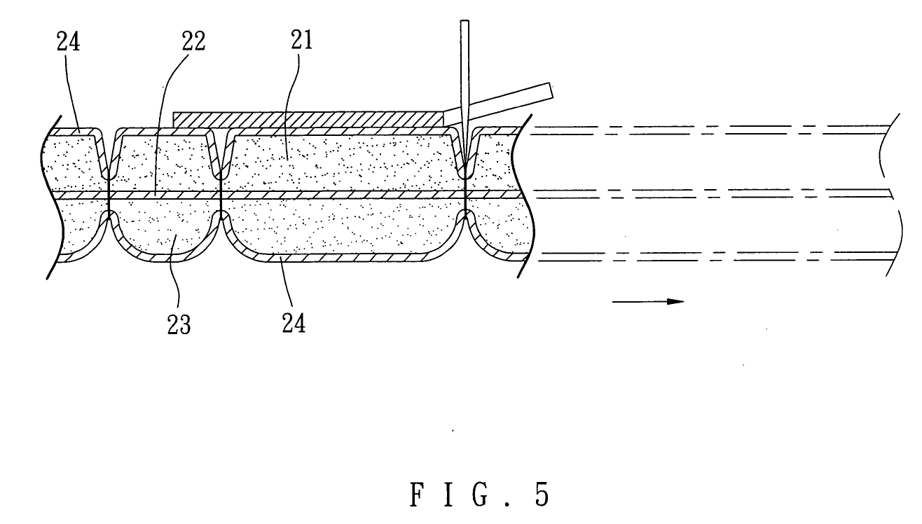

Referring to FIG. 5, because the memory foam layer 21 has the properties of heavy weight and good extension, if only sew the patterns of memory foam layer 21, the sewn portions will not easy to be advanced forward in the sewing process, as a result, the sewing machine will always operate at the fixed sewing position. To improve this problem, the cloth layer 22 will be stuck at the bottom of memory foam layer 21, and then the foam layer 23 will be stuck at the bottom of cloth layer 22 such that the memory foam layer 21 can be molded and can reduce its extension, so as to said padding 20 can be easily advanced to cause a smooth sewing process and three-dimensional patterns of memory foam layer 21 while sewing the patterns, by the means of pulling the cloth layer 22 and foam layer 23.

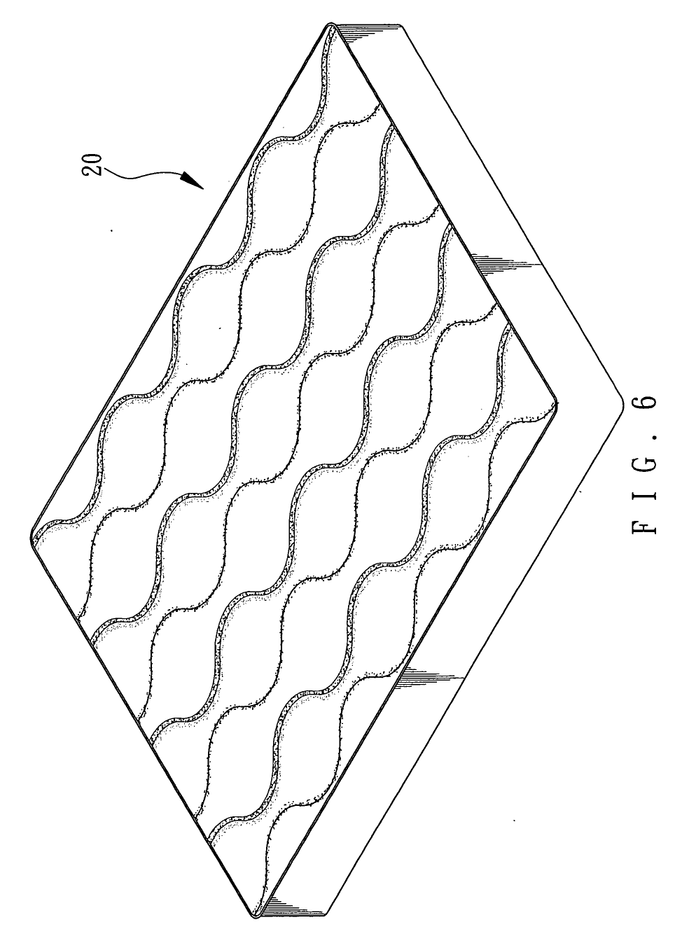

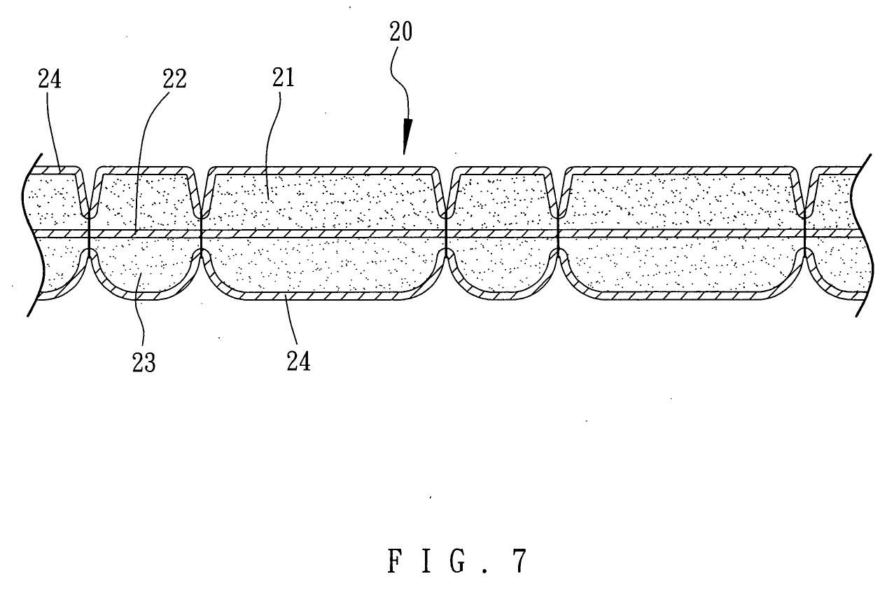

Referring next to FIGS. 6 and 7, after the completion of the sewing patterns of padding 20, the surface of memory foam layer 21 and the bottom of foam layer 23 will appear three-dimensional patterns, so as to enhance the aesthetic appearance of paddings 20. Furthermore, the memory foam layer 21 can provided with the comfortness function as the user lies on the paddings 20.

While we have shown and described various embodiments in accordance with the present invention, it should be clear to those skilled in the art that further embodiments may be made without departing from the scope of the present invention.

What is claimed is:

1. A memory foam padding adapted to sewing patterns of a sewing machine comprising a memory foam layer and a low extension molding member, wherein said molding member is stuck at the bottom of memory foam layer, so as to the memory foam layer and said molding member can be a unitary padding, thereafter, a decoration fabric casing will be covered around the padding, thereby enabling said padding to be easily advanced to cause a smooth sewing process and three-dimensional patterns while sewing the patterns thereof, by using the molding of the molding member.

2. The memory foam padding adapted to sewing patterns of a sewing machine as claimed in claim 1, wherein the molding member is a cloth layer.

3. The memory foam padding adapted to sewing patterns of a sewing machine as claimed in claim 1, wherein a foam layer is stuck on the bottom of molding member.

4. The memory foam padding adapted to sewing patterns of a sewing machine as claimed in claim 1, wherein the memory foam layer has the properties of high density, heavy weight and good extension.

5. The memory foam padding adapted to sewing patterns of a sewing machine as claimed in claim 2, wherein the cloth layer is made of nonwoven fabrics.

6. The memory foam padding adapted to sewing patterns of a sewing machine as claimed in claim 3, wherein the foam layer has the properties of low density, light weight and low extension.
